(19) United States
(12) Patent Application Publication
(10) Pub. No.: US 2012/0072281 A1
(43) Pub. Date: Mar. 22, 2012

(54) METHOD AND SYSTEM TO MONETIZE DOMAIN QUERIES IN SPONSORED SEARCH

(75) Inventors: Chi-Chao Chang, Santa Clara, CA (US); Arun Kumar Gnanamani, Mountain View, CA (US); Ankur Gupta, Sunnyvale, CA (US)

(73) Assignee: Yahool Inc., Sunnyvale, CA (US)

(21) Appl. No.: 12/886,953

(22) Filed: Sep. 21, 2010

(51) Int. Cl. G06Q 30/00; G06F 17/30

(52) U.S. Cl. 705/14.49; 707/709; 707/E17.108

(57) ABSTRACT

Techniques are provided for enabling relevant search results and advertisement selections to be generated in response to domain queries. A query that is input to a search engine is received. The query is analyzed to determine whether the search query is a domain query. If the query is determined to be a domain query, at least one domain related segment is stripped from the domain query to generate a condensed query, the condensed query is tokenized into at least one token, and the token(s) is/are spell corrected to generate at least one query feature. The query feature(s) may be normalized to generate at least one normalized query feature. The query feature(s) is/are provided to an advertisement selector to be used to select one or more advertisements.

### BACKGROUND OF THE INVENTION

1. Field of the Invention

The present invention relates to sponsored search and online advertising.

2. Background

A search engine is an information retrieval system used to locate documents and other information stored on a computer system. Search engines are useful at reducing an amount of time required to find information. One well known type of search engine is a Web search engine which searches for documents, such as web pages, on the “World Wide Web” (also known as “the Web”). Examples of such search engines include Yahoo! Search™ (at http://www.yahoo.com), Microsoft Bing™ (at http://www.bing.com), Ask.com™ (at http://www.ask.com), and Google™ (at http://www.google.com). Online services such as LexisNexis™ and Westlaw™ also enable users to search for documents provided by their respective services, including articles and court opinions. Further types of search engines include personal search engines, mobile search engines, and enterprise search engines that search on intranets, among others.

To perform a search, a user of a search engine typically enters a query into an entry box of the search engine. The query contains one or more words/terms, such as “hazardous waste” or “country music.” The terms of the query are typically selected by the user to as an attempt find particular information of interest to the user. The search engine returns a list of documents relevant to the query. In a Web-based search, the search engine typically returns a list of uniform resource locator (URL) addresses for the relevant documents, which is displayed to the user in a search results page. If the scope of the search resulting from a query is large, the returned list of documents may include thousands or even millions of documents.

“Sponsored search” refers to a form of Internet advertising/marketing that enables advertisers to increase their visibility in the results page of a search engine query. According to sponsored search, an advertiser may pay or provide other compensation for having an advertisement appear in a sponsored section of the results page for one or more particular queries. A user who enters one of the queries into the search engine is provided with a results page that includes the advertisement in the sponsored search section. The sponsored search section is prominently displayed in the results page, to enable the user to easily see and interact with the advertisement. In this manner, an advertiser is enabled to provide advertisements to users that are directly related to their queries, and a search engine owner/operator is enabled to further monetize the search engine.

The search engine entry box has become the starting point for many tasks related to the Web. It enables searching to be performed, but also enables users to navigate to websites. As such, many users enter domain names into the search engine entry box as search queries. Such search queries may be referred to as “domain queries.” Many users enter domain names by mistake into a search engine entry box, such as search engine toolbar (such as the Yahoo!™ toolbar), instead of a web browser's URL address bar, due to the close proximity of the two. For instance, many inexperienced browser users do not understand the difference between the search engine entry box and the URL address bar. Hence, a search engine may receive a substantial amount of domain queries. However, domain queries have been shown to result in little or no sponsored search advertisement coverage, or irrelevant advertisement results. As such, it is desired to find ways to more effectively monetize domain queries.

### BRIEF SUMMARY OF THE INVENTION

Various approaches are described herein for, among other things, enabling relevant search results and advertisement selections to be generated in response to domain queries. A received search query that is detected to be a domain query is converted into one or more query features. The query feature(s) tend to provide more meaning than the domain query. The query feature(s) may be used to select advertisements and/or to generate search results instead of using the domain query itself. In this manner, more relevant advertisements may be selected and/or more relevant search results may be generated.

In one method implementation, a search query that is input to a search engine is received. The user query is analyzed to determine whether the search query is a domain query. If the search query is determined to be a domain query, at least one domain related segment is stripped from the domain query to generate a condensed query, the condensed query is tokenized into at least one token, and the token(s) is/are spell corrected to generate at least one query feature. The query feature(s) may optionally be normalized. The query feature(s) is/are provided to an advertisement selector to be used to select at least one advertisement.

In another implementation, a domain query processing module is provided. The domain query processing module includes a domain query identifier, a domain query cleaner, a domain query tokenizer, and a tokenized query spelling corrector. The domain query identifier receives a user query input to a search engine and determines that the user query is a domain query. The domain query cleaner strips at least one domain related segment from the domain query to generate a condensed query. The domain query tokenizer tokenizes the condensed query into one or more tokens. The tokenized query spelling corrector spell corrects the one or more tokens to generate one or more query features.

The domain query processing module may further include a tokenized query normalizer. The tokenized query normalize normalizes the one or more query features to generate one or more normalized query features.

The one or more query features may be provided to an advertisement selector to be used to select one or more advertisements. The advertisement(s) may be displayed to the user that submitted the query. Furthermore, the one or more query features may be used by a search engine to generate search results that may be displayed to the user that submitted the query.

In another implementation, a search serving system is provided. The search serving system includes a search front end and a domain query processing module. The search front end is configured to receive a user query input to a search engine. The domain query processing module is configured to determine whether the user query is a domain query, and if the user query is determined to be a domain query, to convert the domain query into at least one query feature.

The search serving system may include a search engine and an advertisement selector. The search engine includes the search front end, a search back end, a sponsored search front end, and the domain query processing module. The search back end is configured to generate search results. The sponsored search front end is configured to provide the at least one query feature to the advertisement selector to be used to select at least one advertisement.

Alternatively, the search engine may include the search front end, the search back end, and the sponsored search front end. The advertisement selector may include an advertisement selection front end, an advertisement selection back end, and the domain query processing module. The advertisement selection front end receives the user query from the sponsored search front end. The domain query processing module receives the user query from the advertisement selection front end. The advertisement selection back end receives the at least one query feature from the domain query processing module and is configured to select at least one advertisement based on the at least one query feature.

Computer program products are also described herein that enable domain queries to be converted into query features, that enable advertisements and/or search results to be generated based on the query features, and that enable further embodiments as described herein.

Further features and advantages of the disclosed technologies, as well as the structure and operation of various embodiments, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate embodiments of the present invention and, together with the description, further serve to explain the principles involved and to enable a person skilled in the relevant art(s) to make and use the disclosed technologies.

FIG. 1 shows a block diagram of an example search network, according to an embodiment.

FIG. 2 shows an example query that may be submitted by a user to a search engine.

FIG. 3 shows an example domain query that may be submitted by a user to a search engine.

FIG. 4 shows a block diagram of a search system, according to an example embodiment.

FIG. 5 shows a block diagram of a domain query processing module, according to an example embodiment.

FIG. 6 shows a flowchart for generating one or more query features from a received domain query, according to an example embodiment

FIG. 7 shows a block diagram of a domain query processing module that includes a tokenized query normalizer, according to an example embodiment.

FIG. 8 shows a process for normalizing query features, according to an example embodiment.

FIG. 9 shows a webpage displayed in response to the query “giftflowerbasket.com” submitted to a search engine.

FIG. 10 shows a webpage displayed in response to the query “giftflowerbasket.com” submitted to a search engine, according to an example embodiment.

FIG. 11 shows a webpage displayed in response to the query “realvegasonline.biz” submitted to a search engine.

FIG. 12 shows a webpage displayed in response to the query “realvegasonline.biz” submitted to a search engine, according to an example embodiment.

FIG. 13 shows a webpage displayed in response to the query “flickr.com” submitted to a search engine.

FIG. 14 shows a webpage displayed in response to the query “flickr.com” submitted to a search engine, according to an example embodiment.

FIG. 15 shows a flowchart for processing a domain query at a search system, according to an example embodiment.

FIG. 16 shows a block diagram of a search system, according to an example embodiment.

FIG. 17 shows a flowchart for processing a domain query at a search system, according to an example embodiment.

FIG. 18 shows a block diagram of a search system, according to an example embodiment.

FIG. 19 is a block diagram of a computer in which embodiments may be implemented.

The features and advantages of the disclosed technologies will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE INVENTION

### I. Introduction

The following detailed description refers to the accompanying drawings that illustrate exemplary embodiments of the present invention. However, the scope of the present invention is not limited to these embodiments, but is instead defined by the appended claims. Thus, embodiments beyond those shown in the accompanying drawings, such as modified versions of the illustrated embodiments, may nevertheless be encompassed by the present invention.

References in the specification to “one embodiment,” “an embodiment,” “an example embodiment,” or the like, indicate that the embodiment described may include a particular feature, structure, or characteristic, but every embodiment may not necessarily include the particular feature, structure, or characteristic. Moreover, such phrases are not necessarily referring to the same embodiment. Furthermore, when a particular feature, structure, or characteristic is described in connection with an embodiment, it is submitted that it is within the knowledge of one skilled in the art to implement such feature, structure, or characteristic in connection with other embodiments whether or not explicitly described.

Example embodiments are described in the following sections.

### II. Example Embodiments for a Sponsored Search Environment and for Domain Query Processing

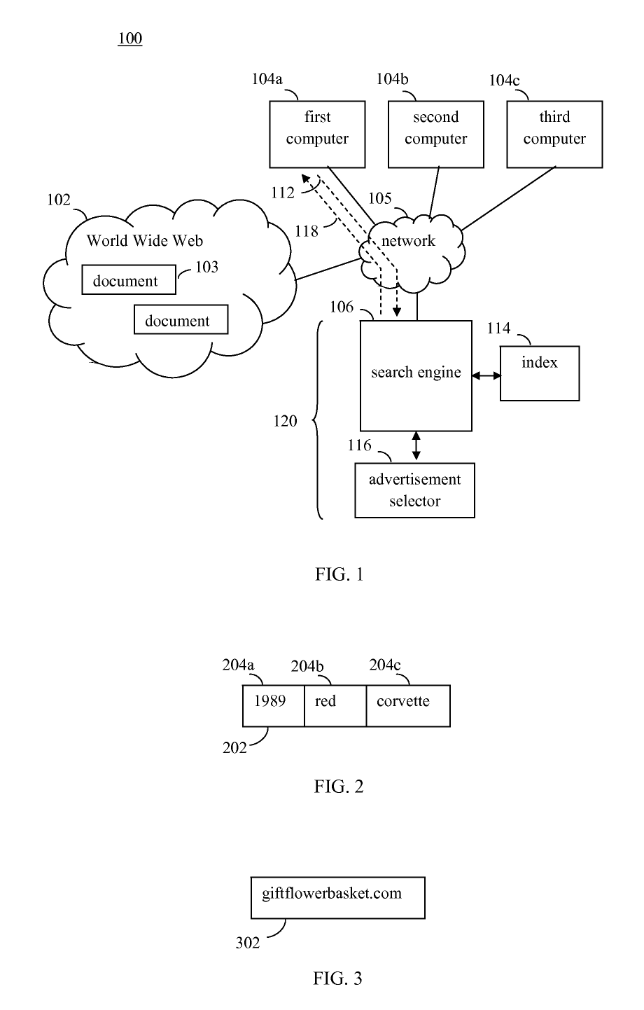

Embodiments of the present invention enable more effective search results and advertisements to be selected in response to domain queries in sponsored search environments. Embodiments may be implemented in a variety of environments, including sponsored search environments. For instance, FIG. 1 shows a search network 100, which is an example environment in which sponsored search may be implemented. As shown in FIG. 1, network 100 includes a search system 120. Search system 120 is configured to provide search results for a received search query 112, and to provide matching advertisements. As shown in FIG. 1, search system 120 includes a search engine 106 and an advertisement selector 116. These and further elements of network 100 are described as follows.

As shown in FIG. 1, one or more computers 104, such as first-third computers 104a-104c, are connected to a communication network 105. Network 105 may be any type of communication network, such as a local area network (LAN), a wide area network (WAN), or a combination of communication networks. In embodiments, network 105 may include the Internet and/or an intranet. Computers 104 can retrieve documents from entities over network 105. Computers 104 may each be any type of suitable electronic device, typically having a display and having web browsing capability, such as a desktop computer (e.g., a personal computer, etc.), a mobile computing device (e.g., a personal digital assistant (PDA), a laptop computer, a notebook computer, a tablet computer (e.g., an Apple iPad™), a netbook, etc.), a mobile phone (e.g., a cell phone, a smart phone, etc.), or a mobile email device. In embodiments where network 105 includes the Internet, numerous documents (including a document 103) that form a portion of World Wide Web 102, are available for retrieval by computers 104 through network 105. On the Internet, documents may be identified/located by a uniform resource locator (URL), such as http://www.documents.com/documentX, and/or by other mechanisms. Computers 104 can access document 103 through network 105 by supplying a URL corresponding to document 103 to a document server (not shown in FIG. 1).

As shown in FIG. 1, search engine 106 is coupled to network 105. Search engine 106 accesses a stored index 114 that indexes documents, such as documents of World Wide Web 102. A user of computer 104a who desires to retrieve one or more documents relevant to a particular topic, but does not know the identifier/location of such a document, may submit a query 112 to search engine 106 through network 105. For instance, the user may enter query 112 into a search engine entry box displayed by computer 104a (e.g., by a web browser). Search engine 106 receives query 112, and analyzes index 114 to find documents relevant to query 112. For example, search engine 106 may determine a set of documents indexed by index 114 that include terms of query 112. The set of documents may include any number of documents, including tens, hundreds, thousands, or even millions of documents. Search engine 106 may use a ranking or relevance function to rank documents of the retrieved set of documents in an order of relevance to the user. Documents of the set determined to most likely be relevant may be provided at the top of a list of the returned documents in an attempt to avoid the user having to parse through the entire set of documents.

Search engine 106 may be implemented in hardware, software, firmware, or any combination thereof. For example, search engine 106 may include software/firmware that executes in one or more processors of one or more computer systems, such as one or more servers. Examples of search engine 106 that may be accessible through network 105 include, but are not limited to, Yahoo! Search™ (at http://www.yahoo.com), Microsoft Bing™ (at www.bing.com), Ask.com™ (at http://www.ask.com), and Google™ (at http://www.google.com).

FIG. 2 shows an example search query 202 that may be submitted by a user of one of computers 104a-104c of FIG. 1 to search engine 106. Query 202 is an example of query 112, and includes one or more terms or features 204, such as first, second, and third features 204a-204c shown in FIG. 2. Any number of features 204 may be present in a query. As shown in FIG. 2, features 204a-204c of query 112 are “1989,” “red,” and “corvette.” Search engine 106 applies these features 204a-204c to index 114 to retrieve a document locator, such as a URL, for one or more indexed documents that match 1989,” “red,” and “corvette,” and may order the list of documents according to a ranking. The list of documents may be displayed to the user in response to query 202.

Furthermore, in a sponsored search environment, one or more advertisements may be selected for display to the user along with the documents displayed to the user in response to query 112. “Sponsored search” refers to a form of Internet advertising/marketing that enables advertisers to increase their visibility in the results page of a search engine query. In sponsored search, an advertiser may pay or provide other consideration for having information, such as a link to a website of the advertiser, appear in a sponsored section of the results webpage for one or more particular queries. The sponsored section is prominently displayed in the results page, to enable the user to easily view and interact with the displayed information of the advertiser. In this manner, an advertiser is enabled to provide advertisements to users that are directly related to their queries, and a search engine owner/operator is enabled to further monetize the search engine.

For example, network 100 may include advertisement selector 116 that is configured to select advertisements related to received queries for display. Advertisement selector 116 may receive query 112 from search engine 106. Advertisement selector 116 may include a mapping of queries to advertisers/advertisements. Advertisement selector 116 may determine from the mapping whether advertisements are present that correspond to query 112, and if so, to select one or more of the corresponding advertisements to be displayed as sponsored search results for query 112. Advertisement selector 116 may provide an indication of the selected advertisements to search engine 106. Search engine 106 may generate a search results page 118 that is transmitted to first computer 104a to be displayed (e.g., by a browser), and that includes any determined search results and selected advertisements for query 112.

In some instances, query 112 may be a domain query. A domain query is a domain name (e.g., an address for a website, such as a URL (uniform resource locator)) that a user entered into the search engine entry box as a query. Frequently, a domain name entered as a domain query has a domain-related prefix, such as “http://www.” or “www.”, and/or has a domain-related suffix, such as “.com”, “.gov”, or “.ca”. For instance, FIG. 3 shows an example domain query 302 that may be entered into a search engine entry box. In the example of FIG. 3, domain query 302 includes a single term or feature of “giftflowerbasket.com,” which is a domain name. Further examples of domain names that may be provided as domain queries are shown below for illustrative purposes:

realvegasonline.biz
onlineblackjack.com
fllickr.com
executivediary.com
goldonline.com
. . .

Hundreds of thousands of domain names associated with IP (Internet protocol) addresses on the World Wide Web currently exist, and their numbers are increasing. Any such domain names may be submitted by users as domain queries.

Domain queries form a significant portion of a total query volume, and thus provide a monetization opportunity. Most advertisers do not bid on actual domain names when selecting the query terms that cause display of their advertisements, and do not provide domain names in their provided advertisement creatives by default. Instead, advertisers tend to bid on human readable keywords. If advertisers did bid on domain names, this would lead to a sharp increase in the number of query keywords due to the various possible permutations and combinations. For example, there is more than one way of representing a same domain name, such as by including or omitting the “http://” prefix, the “www” portion of the domain name, etc. As a result, many techniques for matching queries to advertisements fail to match domain queries to advertisements. Even advanced matching systems, which perform contextual matching, consider a domain name to be a single feature for matching with advertisement keywords, and as a result are unable to ascertain the user's query intent.

Embodiments of the present invention enable improved matching of advertisements to domain queries. In embodiments, a received domain query is converted into one or more features that are better suited for matching advertisements. Such features may also be used to provide improved search results for the domain query.

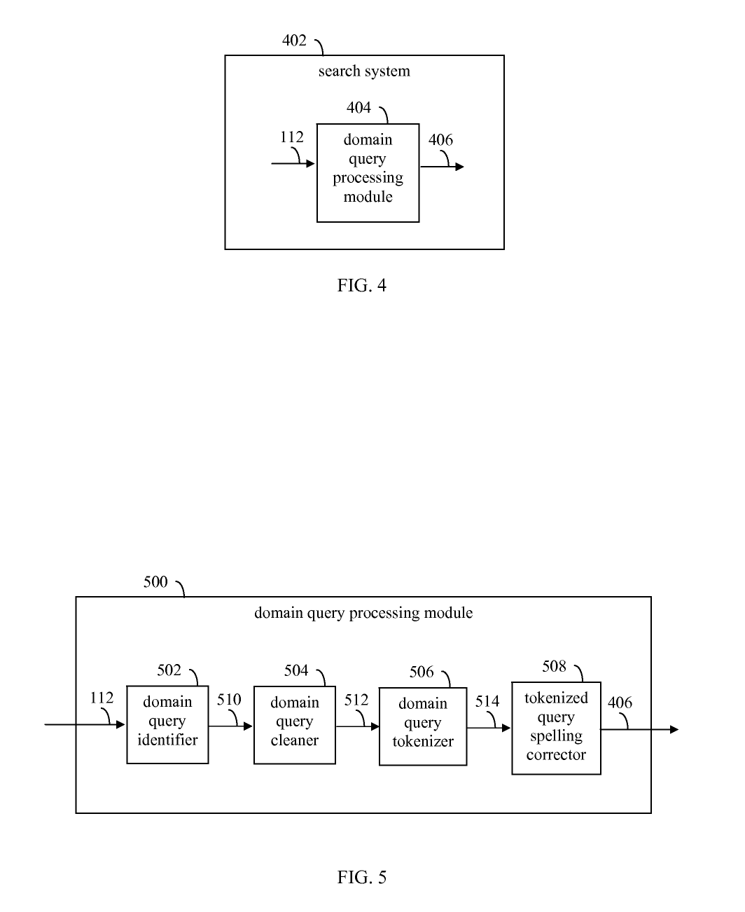

For instance, FIG. 4 shows a block diagram of a search system 402, according to an example embodiment. Similarly to search system 120 of FIG. 1, search system 402 may include a search engine (e.g., search engine 106) and an advertisement selector (e.g., advertisement selector 116). Furthermore, as shown in FIG. 4, search system 402 includes a domain query processing module 404. Domain query processing module 404 is configured to process domain queries received as query 112, such as domain query 302 of FIG. 3, to generate at least one query feature 406. Query feature(s) 406 may be used to enable improved advertisement selection for the domain queries. For instance, domain query processing module 404 may tokenize domain queries into one or more features (e.g., may split a domain query into individual word or phrase units). A domain query such as “http//www.newyorktimes.com” may be tokenized into “new york times” by domain query processing module 404, for example. The three features of “new,” “york,” and “times” or the two features of “new york” and “times” (where the features “new” and “york” may be grouped to represent the feature of “new york”) may be used to generate search results for the domain query of “http//www.newyorktimes.com,” and/or may be used to select advertisements for the domain query of “http//www.newyorktimes.com.” Such search results and/or selected advertisements may be more relevant than search results and/or selected advertisements based on the single feature of “http//www.newyorktimes.com.”

Example embodiments for domain query processing module 404, and for further techniques for processing domain queries and enabling improved advertisement selection and search results are described in further detail in the following sections.

### III. Example System and Method Embodiments for a Domain Query Processing Module

Domain query processing module 404 may be configured in various ways, in embodiments. For instance, FIG. 5 shows a block diagram of a domain query processing module 500, according to an example embodiment. Domain query processing module 500 is an example of domain query processing module 404 of FIG. 4. As shown in FIG. 5, domain query processing module 500 includes a domain query identifier 502, a domain query cleaner 504, a domain query tokenizer 506, and a tokenized query spelling corrector 508. These elements of domain query processing module 500 are described as follows.

As shown in FIG. 5, domain query identifier 502 receives query 112. Domain query identifier 502 is configured to determine whether query 112 is a domain query. If domain query identifier 502 determines that query 112 is a domain query, domain query identifier 502 outputs the received query as domain query 510. For instance, in embodiments, domain query identifier 502 may search the text of search query 112 for one or more predetermined domain name indicators (e.g., text strings) that if present, indicate query 112 to be a domain query. If none of the predetermined domain name indicators are present, domain query identifier 502 indicates query 112 as not being a domain query.

For example, in an embodiment, domain query identifier 502 may be configured to search the text of query 112 for predetermined generic top-level domains (gTLD) text strings, country code top-level domain (ccTLD) text strings, and/or further text strings that are suffixes to domain names. Example gTLD text strings include “.com”, “.net”, “.org”, “.biz”, etc. Example ccTLD text strings include “.ca” (for Canadian domain names), “.de” (for German domain names), and ccTLD text strings corresponding to any other country. If domain query identifier 502 finds such a domain name suffix, query 112 is determined to be a domain query. In another embodiment, domain query identifier 502 may be configured to search the text of query 112 for predetermined text string prefixes that indicate domain names, including “http://”, “http://www”, “https://www”, “www.”, etc. If domain query identifier 502 finds such a domain name prefix, query 112 is determined to be a domain query. In embodiments, domain query identifier 502 may be configured to search the text of query 112 for these, additional, and/or alternative text strings that indicate that query 112 is a domain query.

For instance, a user may submit “www.giftflwerbaskets.com” to a search engine as query 112. Domain query identifier 502 may search the text of “www.giftflwerbaskets.com” for one or more domain name indicators. For instance, domain query identifier 502 may locate the domain name prefix of “www.” and the domain name suffix “.com”, and may therefore indicate “www.giftflwerbaskets.com” as being a domain query. As such, domain query identifier 502 may output “www.giftflwerbaskets.com” as domain query 510.

As shown in FIG. 5, domain query cleaner 504 receives domain query 510. Domain query cleaner 504 is configured to “clean up” domain query 510. For example, domain query cleaner 504 may be configured to remove or strip one or more domain-related segments from domain query 510 to generate a condensed query 512. In an embodiment, domain query cleaner 504 may be configured to remove the predetermined text strings searched for by domain query identifier 502, as described above, from domain query 510 to generate condensed query 512. Domain query cleaner 504 may be configured to remove domain name prefixes, such as “http://”, “http://www”, “https://www”, and “www.”, and may be configured to remove domain name suffixes, such as “.com”, “.net”, “.org”, “.biz”, “.ca”, “.de”, etc.

For instance, in the current example, where “www.giftflwerbaskets.com” is received as domain query 510, domain query cleaner 504 may strip “www.” and “.com” from “www.giftflwerbaskets.com” to generate “giftflwerbaskets” as condensed query 512.

Domain query tokenizer 506 receives condensed query 512. Domain query tokenizer 506 is configured to tokenize (e.g., separate) condensed query 512 into at least one token 514, having the form of multiple meaningful tokens or words (if condensed query 512 is not a single word or token, but is separable into multiple words or tokens). For example, domain query tokenizer 506 may be configured to use taxonomy based matching, dictionary based matching, and/or other techniques to tokenize condensed query 512. For instance, persons skilled in the relevant art(s) will know of existing open source and/or proprietary techniques (such taxonomy based matching, dictionary based matching, etc.) for tokenizing condensed query 512 to generate token(s) 514.

Continuing the current example, where “giftflwerbaskets” is received as condensed query 512, domain query tokenizer 506 may tokenize “giftflwerbaskets” into the three tokens of “gift”, “flwer”, and “baskets”, which are included in token(s) 514.

As shown in FIG. 5, tokenized query spelling corrector 508 receives token(s) 514. Tokenized query spelling corrector 508 is configured to perform spell checking and correction on token(s) 514 to generate at least one query feature 406, such that each token of token(s) 514 is spelled correctly in query feature(s) 406. For instance, users entering queries into search engine entry boxes frequently misspell queries and/or introduce other typographical errors. Tokenized query spelling corrector 508 is configured to correct any such spelling and/or any other typographical mistakes in token(s) 514 to generate query feature(s) 406. Tokenized query spelling corrector 508 may use conventional or proprietary spell correction techniques, as would be known to persons skilled in the relevant art(s).

For example, continuing the current example, where “gift”, “flwer”, and “baskets” are received in token(s) 514, tokenized query spelling corrector 508 may correct the spelling of “flwer” to “flower,” to output query feature(s) 406 as “gift”, “flower”, and “baskets”.

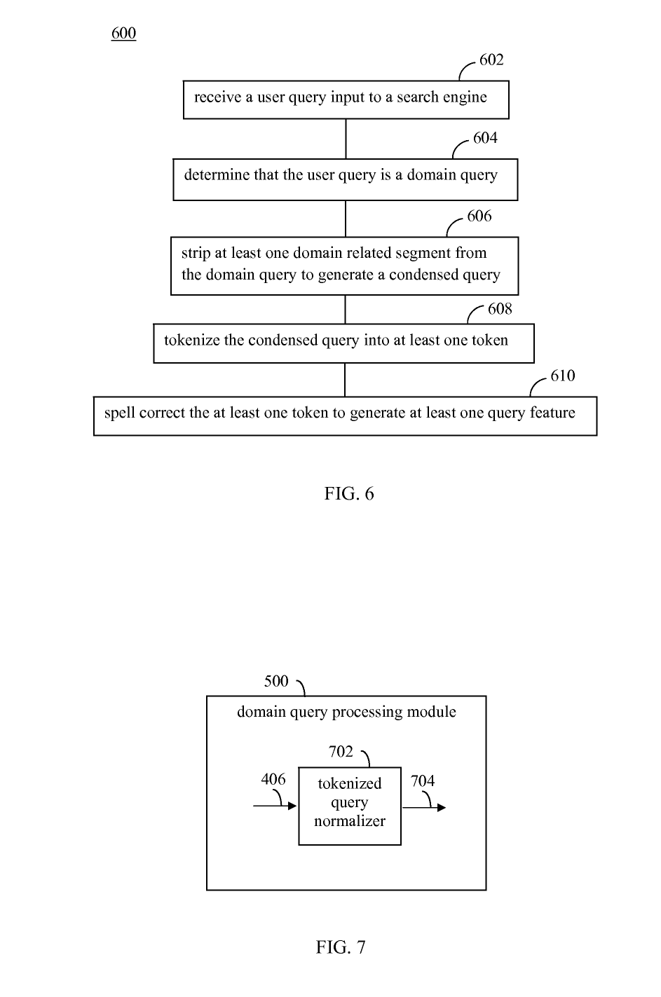

As such, domain query processing module 500 of FIG. 5 may receive a query 112, and may generate query feature(s) 406. For instance, domain query processing module 500 may operate according to FIG. 6. FIG. 6 shows a flowchart 600 for generating one or more query features from a received domain query, according to an example embodiment. Flowchart 600 is described as follows with respect to domain query processing module 500 for illustrative purposes. Further structural and operational embodiments will be apparent to persons skilled in the relevant art(s) based on the following description of flowchart 600.

Flowchart 600 begins with step 602. In step 602, a user query input to a search engine is received. For example, as shown in FIG. 5, domain query identifier 502 receives query 112.

In step 604, the user query is determined to be a domain query. For instance, in an embodiment, as described above, domain query identifier 502 may analyze query 112 (e.g., search query 112 for one or more domain name indicators), and may determine query 112 to be a domain query. Domain query identifier 502 generates domain query 510 to include query 112, when query 112 is determined to be a domain query.

In step 606, at least one domain related segment is stripped from the domain query to generate a condensed query. For example, in an embodiment, as described above, domain query cleaner 504 receives domain query 510, and cleans domain query 510 (e.g., removes one or more domain related segments of domain query 510). Domain query cleaner 504 generates the cleaned version of domain query 510 as condensed query 512.

In step 608, the condensed query is tokenized into at least one token. For instance, in an embodiment, as described above, domain query tokenizer 506 receives condensed query 512, and separates condensed query 512 into multiple words or tokens, if condensed query 512 is separable into multiple words or tokens. Domain query tokenizer 506 outputs the multiple words or tokens as token(s) 514. If condensed query 512 is not separable, domain query tokenizer 506 outputs condensed query 512 as a single token 514.

In step 610, the at least one token is spell corrected to generate at least one query feature. For example, in an embodiment, as described above, tokenized query spelling corrector 508 receives token(s) 514, and performs spell correction on token(s) 514. Tokenized query spelling corrector 508 outputs the spell corrected version of token(s) 514 as query feature(s) 406.

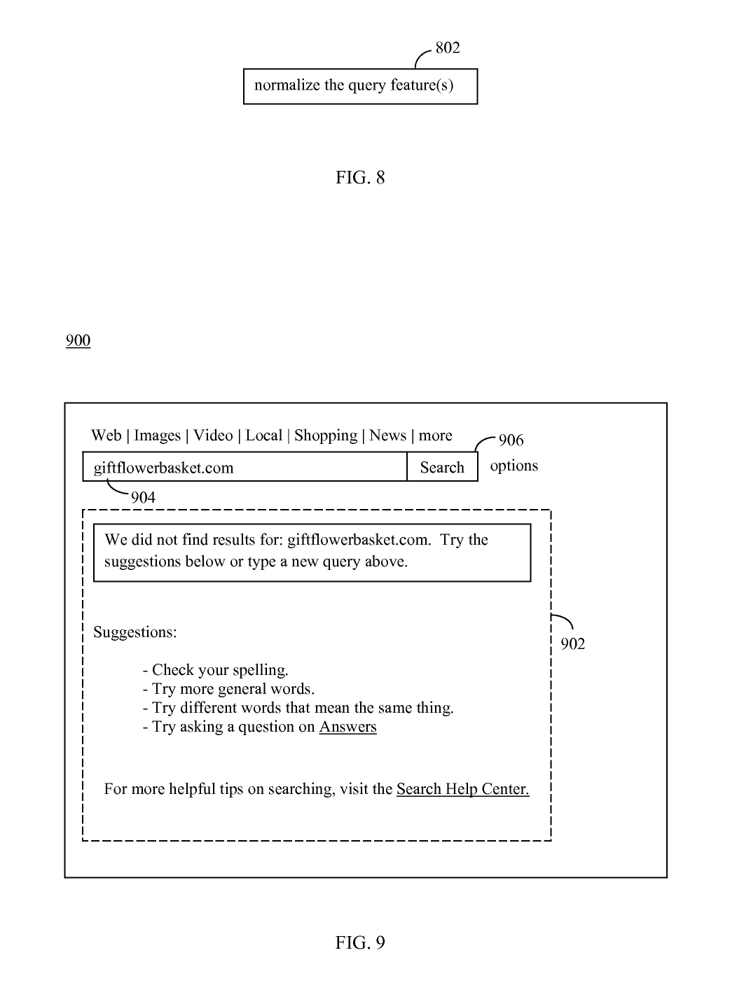

In an embodiment, domain query processing module 500 may optionally be further configured to canonicalize or normalize query feature(s) 406 into a same form as the keywords of advertisement creatives. For instance, FIG. 7 shows a block diagram of domain query processing module 500, according to an example embodiment. As shown in FIG. 7, domain query processing module 500 includes a tokenized query normalizer 702. Domain query processing module 500 may include tokenized query normalizer 702 in addition to the elements of domain query processing module 500 shown in FIG. 5, in an embodiment. Tokenized query normalizer 702 is configured to normalize query feature(s) 406 to generate normalized query feature(s) 704. In an embodiment, tokenized query normalizer 702 may perform a step 802 shown in FIG. 8. In step 802, the query feature(s) is/are normalized. For example, in embodiments, step 802 may be performed in flowchart 600 (FIG. 6) prior to step 610 (to normalize token(s) 514) or after step 610 (to normalize query feature(s) 406).

Tokenized query normalizer 702 may be configured to perform token/feature normalization in one or more ways. For instance, tokenized query normalizer 702 may be configured to perform one or more of alphabetically sorting tokens or query features, converting a plural form of a token or query feature to singular form, converting a spelling of a token or query feature that may have multiple spellings to a common spelling, etc.

For instance, continuing the example from above, where “gift”, “flower”, and “baskets” are received in query feature(s) 704, tokenized query spelling corrector 508 may normalize “baskets” (plural form) to “basket” (singular form), to generate normalized query feature(s) 704 as “gift”, “flower”, and “basket”. In another example, tokenized query spelling corrector 508 may remove plural forms and may reorder query feature(s) 704 in an alphabetical order, to output normalized query feature(s) 704 as “basket”, “flower”, and “gift”.

As such, the generated query features (e.g., query feature(s) 406 or normalized query feature(s) 704) may be used to generate search results and/or to select relevant advertisements. Note that the query features generated by domain query processing module 500 are different from the features of the original query input by the user (e.g., “www.giftflwerbaskets.com” may be modified to “gift”, “flower”, and “basket”, to “basket”, “flower”, and “gift”, or to other form), but an intent of the original query is maintained and is more precisely indicated by the generated query features.

For purposes of illustration, Table 1 shown below lists some examples for query 112, and example corresponding query feature(s) 406 (or query feature(s) 704) that may be generated by domain query processing module 500.

TABLE 1

| Input query 112 | Output query features 406 or 704 |
|---|---|
| realvegasonline.biz | real vegas online |
| onlineblackjack.com | blackjack online |
| executivediary.com | executive diary |
| flickr.com | Flickr |
| goldonline.com | gold online |

In another example, a received query 112 such as “make money online” may not be determined to be a domain query by domain query identifier 502. As such the query is not further processed by domain query processing module 500.

The following section describes examples of improved search results and selected advertisements enabled by embodiments of the present invention.

### IV. Examples of Search Results and Selected Advertisements Based on Embodiments

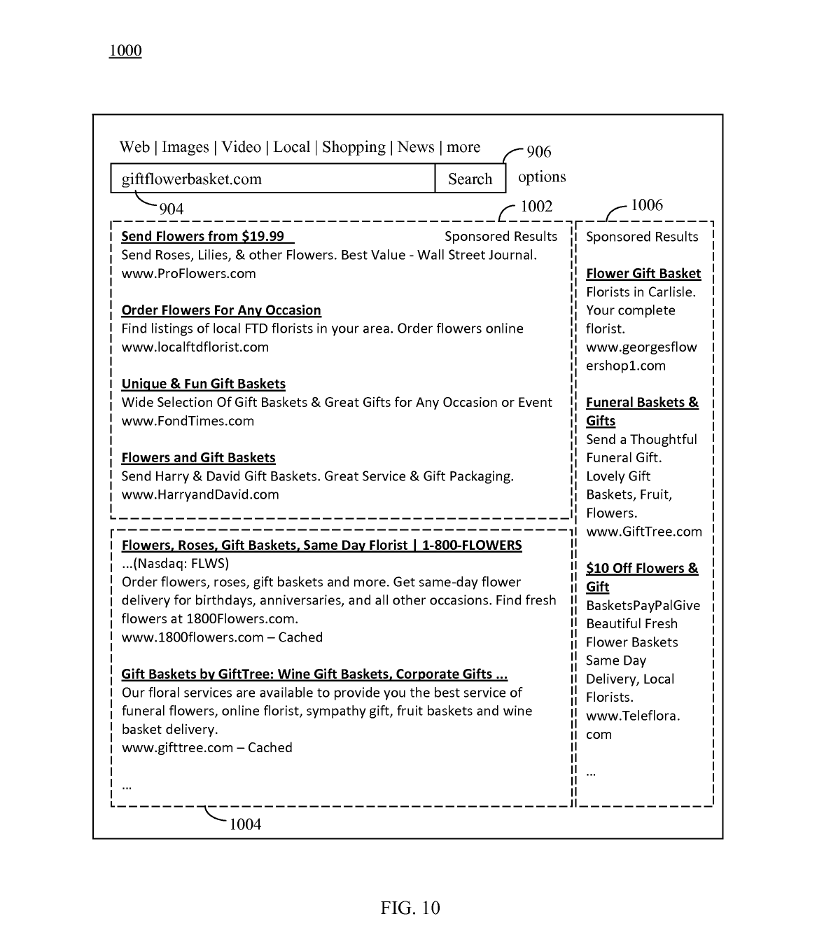

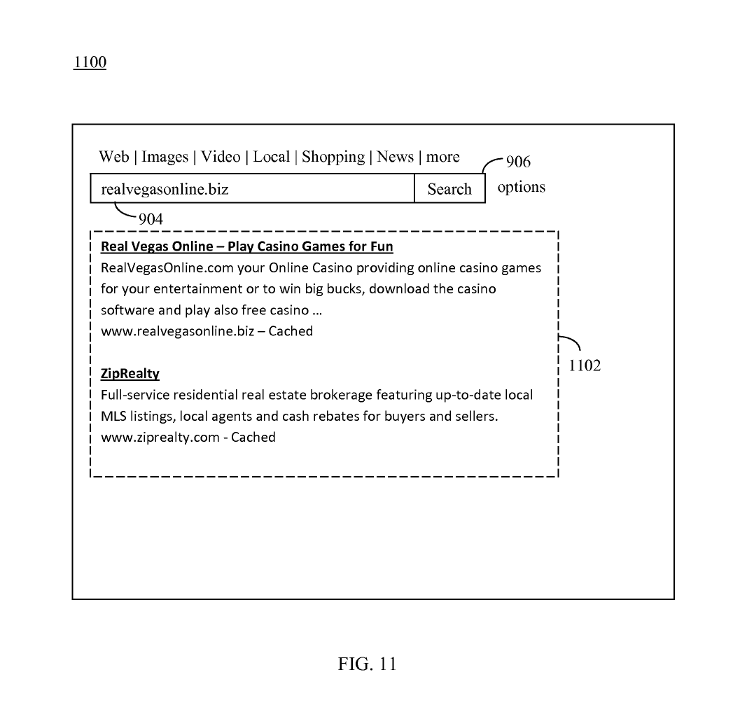

As described above, embodiments enable improved search results and improved selection of relevant advertisements when compared to conventional techniques for handling queries. Examples of search results and selected advertisements are described as follows with respect to FIGS. 9-14, including search results and advertisements selected based on domain queries according to conventional techniques and selected according to embodiments of the present invention. Such search results and selected advertisements are provided for purposes of illustration and are not intended to be limiting.

For example, FIG. 9 shows a webpage 900 displayed in response to the query “giftflowerbasket.com” submitted to a search engine. Webpage 900 is generated by a search engine, such as search engine 106, according to conventional techniques. As shown in FIG. 9, webpage 900 includes a search results region 902, a search query entry box 904, and a search button 906. A user is enabled to enter a search query into search query entry box 904, such as “giftflowerbasket.com” shown in FIG. 9. The user may interact with (e.g., click on, etc.) search button 906 to cause the query entered into entry box 904 to be submitted to search engine 106. The search results for the submitted query are generated and returned by search engine 106, and displayed in search results region 902. Note that the layout of webpage 900 shown in FIG. 9 (and of the further webpages shown in FIGS. 10-14) is an example layout of a web page user interface for interacting with search engine 106, and is not intended to be limiting. In other embodiments, webpage 900 may have other layouts.

As shown in search results region 902 in FIG. 9, in response to the search query of “giftflowerbasket.com”, search engine 106 did not return any search results. Instead, search engine 106 provided a message indicating that results were not found for the search query of “giftflowerbasket.com”, and that the user may desire to modify the search query in a manner that may allow search engine 106 to generate search results. For example, the message indicates that the user may want to modify the spelling of the search query, to try more general words, to try different words, etc.

As such, because the search query of “giftflowerbasket.com” was processed according to conventional techniques (i.e., was not converted into query features), search engine 106 was not able to generate search results. Furthermore, no advertisements were able to be selected for search query “giftflowerbasket.com” (e.g., by advertisement selector 116 of FIG. 1).

In contrast, FIG. 10 shows a webpage 1000 displayed in response to the query “giftflowerbasket.com” submitted to a search engine, according to an example embodiment. Webpage 1000 is generated by a search engine according to an embodiment where the query “giftflowerbasket.com” is processed as a domain query. As shown in FIG. 10, webpage 1000 includes search query entry box 904, search button 906, a first sponsored advertisements results region 1002, a search results region 1004, and a second sponsored advertisements results region 1006. Similarly to FIG. 9, in FIG. 10, a user is enabled to enter a search query into search query entry box 904, such as “giftflowerbasket.com” shown in FIG. 10. According to the embodiment of FIG. 10, the query “giftflowerbasket.com” is processed by domain query processing module 402 to generate the query features of “basket”, “flower,” and “gift”. Search results and selected advertisements are enabled to be generated in response to the query based on the query features of “basket”, “flower,” and “gift”.

As shown in FIG. 10, search results for the submitted query are generated and returned by the search engine, and displayed in search results region 1004. As shown in FIG. 10, search results region 1004 includes a list of search results generated based on the query features of “basket”, “flower,” and “gift”. Furthermore, advertisements for the submitted query are selected and returned by the advertisement selector, and displayed in first and second sponsored advertisements results regions 1002 and 1006. In the example of FIG. 10, first sponsored advertisements results region 1002 is a top-most or “North” region for display of advertisements, displayed above search results region 1004 in webpage 1000. Second sponsored advertisements results region 1006 is a right-most or “East” region for display of advertisements. The most relevant one or more of the selected advertisements (e.g., four advertisements in the example of FIG. 10) may be displayed in first sponsored advertisements results region 1002, and a next most relevant one or more of the selected advertisements (e.g., three advertisements in the example of FIG. 10) may be displayed in second sponsored advertisements results region 1006.

As shown in FIG. 10, the search results displayed in search results region 1004 are relevant to the query of “giftflowerbasket.com”, including first and second search results for florists. Furthermore, the selected advertisements displayed in first and second sponsored advertisements results regions 1002 and 1006 are relevant to the query of “giftflowerbasket.com”, including advertisements for sending flowers, ordering flowers, gift baskets, funeral baskets, gifts, etc.

As such, in FIG. 10, because the search query of “giftflowerbasket.com” was processed according to embodiments to generate the query features of “basket”, “flower,” and “gift”, relevant search results were able to be generated in response to the query, while in the conventional example of FIG. 9, no search results were able to be generated. Furthermore, in FIG. 10, because the search query of “giftflowerbasket.com” was processed according to embodiments to generate the query features of “basket”, “flower,” and “gift”, relevant advertisements were able to be generated, while in the conventional example of FIG. 10, no advertisements were able to be selected.

FIG. 11 shows a webpage 1100 displayed in response to the query “realvegasonline.biz” submitted to a search engine. Webpage 1100 is generated by a search engine, such as search engine 106, according to conventional techniques. As shown in FIG. 11, webpage 1100 includes a search results region 1102, search query entry box 904, and search button 906. The search results for the submitted query are generated and returned by search engine 106, and displayed in search results region 1102. As shown in search results region 1102, in response to the search query of “realvegasonline.biz”, search engine 106 returned two search results. However, no advertisements were able to be selected for search query “realvegasonline.biz” (e.g., by advertisement selector 116 of FIG. 1).

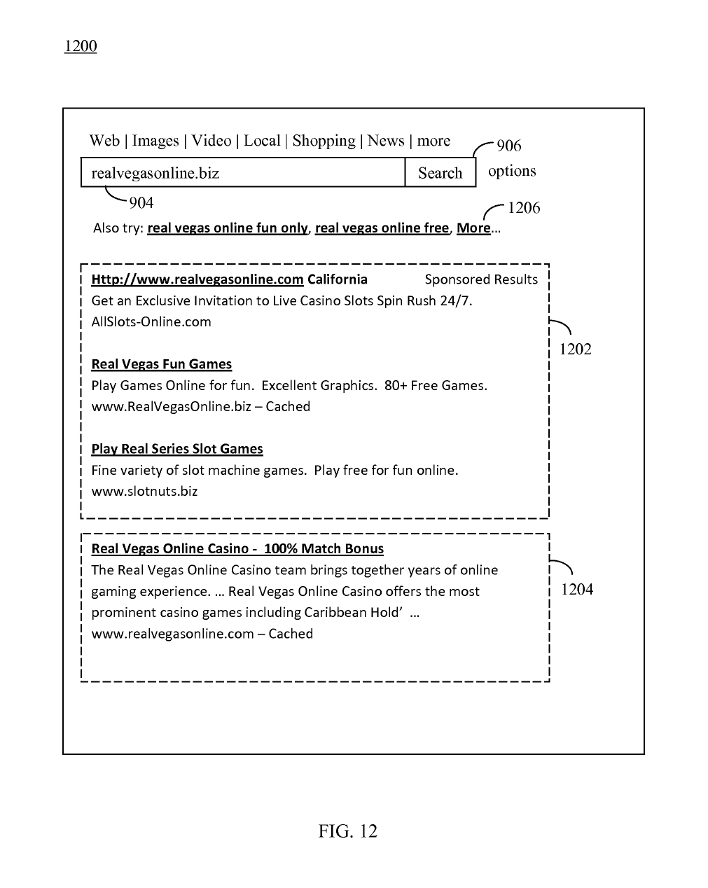

In contrast, FIG. 12 shows a webpage 1200 displayed in response to the query “realvegasonline.biz” submitted to a search engine, according to an example embodiment. Webpage 1200 is generated by a search engine according to an embodiment where the query “realvegasonline.biz” is processed as a domain query. As shown in FIG. 12, webpage 1200 includes search query entry box 904, search button 906, a sponsored advertisements results region 1202, a search results region 1204, and suggested search queries 1206. Similarly to FIG. 11, in FIG. 12, a user is enabled to enter a search query into search query entry box 904, such as “realvegasonline.biz” shown in FIG. 12. According to the embodiment of FIG. 12, the query “realvegasonline.biz” is processed by domain query processing module 402 to generate the query features of “real”, “vegas”, and “online”. As such, search results and selected advertisements are enabled to be generated in response to the query.

As shown in FIG. 12, search results for the submitted query are generated and returned by the search engine, and displayed in search results region 1204. As shown in FIG. 12, search results region 1204 includes a list of search results generated based on the query features of “real”, “vegas”, and “online”. Furthermore, advertisements for the submitted query are selected and returned by the advertisement selector, and displayed in sponsored advertisements results regions 1202. In the example of FIG. 12, sponsored advertisements results region 1202 is a top-most or “North” region for display of advertisements, displayed above search results region 1204 in webpage 1200. The most relevant one or more of the selected advertisements (e.g., three advertisements in the example of FIG. 12) may be displayed in sponsored advertisements results region 1202.

As shown in FIG. 12, the search results displayed in search results region 1204 are relevant to the query of “realvegasonline.biz”, including search results for an online casino. Furthermore, the selected advertisements displayed in sponsored advertisements results region 1202 are relevant to the query of “realvegasonline.biz”, including advertisements online casinos, games, slot machines, etc. Still further, several suggested queries generated based on “real”, “vegas”, and “online” are displayed as suggested search queries 1206 between entry box 904 and sponsored advertisements results region 1202. A user may select a suggested search query of suggested search queries 1206 to perform another search. Such suggested search queries were not generated in the conventional example of FIG. 11 based on the query of “realvegasonline.biz”.

As such, in FIG. 12, because the search query of “realvegasonline.biz” was processed according to embodiments to generate the query features of “real”, “vegas”, and “online”, relevant search results were able to be generated in response to the query, while in the conventional example of FIG. 11, search results were also able to be generated, although such search results may be less relevant than those generated based on the query features of “real”, “vegas”, and “online”. Furthermore, in FIG. 12, because the search query of “realvegasonline.biz” was processed according to embodiments to generate the query features of “real”, “vegas”, and “online”, relevant advertisements were able to be selected, while in the conventional example of FIG. 11, no advertisements were able to be selected.

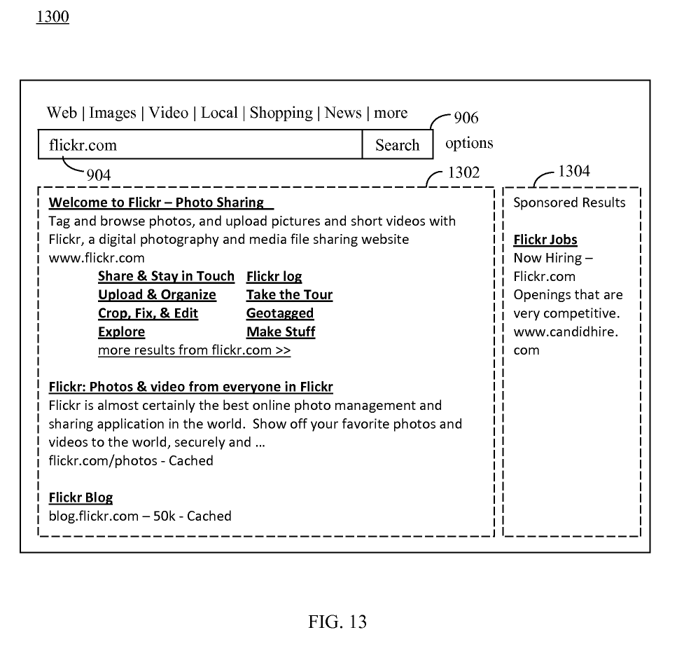

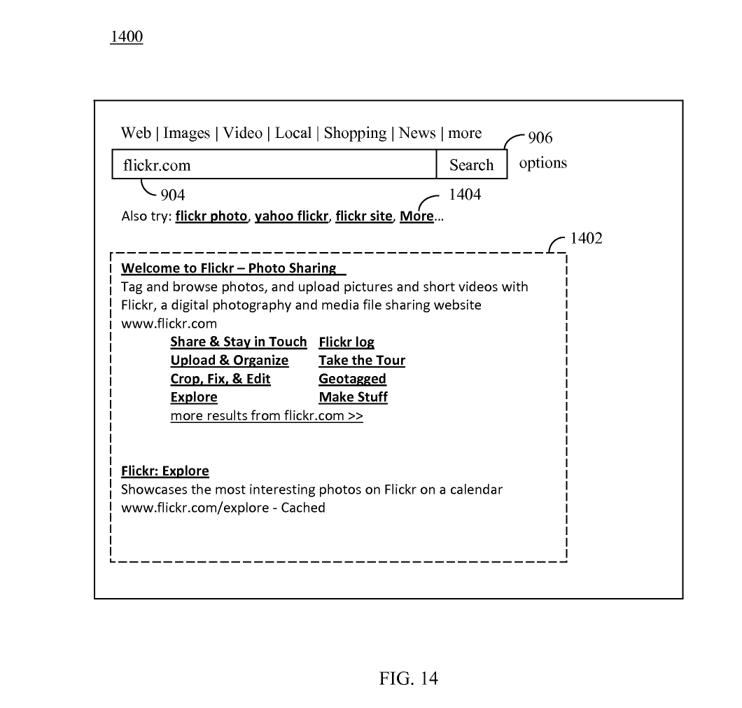

FIG. 13 shows a webpage 1300 displayed in response to the query “flickr.com” submitted to a search engine. Webpage 1300 is generated by a search engine, such as search engine 106, according to conventional techniques. As shown in FIG. 13, webpage 1300 includes a search results region 1302, a sponsored advertisements results region 1304, a search query entry box 904, and search button 906. The search results for the submitted query are generated and returned by search engine 106, and displayed in search results region 1302. As shown in search results region 1302, in response to the search query of “flickr.com”, search engine 106 returned three search results. Furthermore, an advertisement was selected for search query “flickr.com” (e.g., by advertisement selector 116 of FIG. 1) and displayed in sponsored advertisements results region 1304. Sponsored advertisements results region 1304 is displayed as a right-most or “East” region for display of advertisements. However, the displayed advertisement, an advertisement for “www.candidhire.com” appears to be a user information gathering site for offering surveys etc., is not a typical job board, and thus is not particularly relevant to the query of “flickr.com”.

In contrast, FIG. 14 shows a webpage 1400 displayed in response to the query “flickr.com” submitted to a search engine, according to an example embodiment. Webpage 1400 is generated by a search engine according to an embodiment where the query “flickr.com” is processed as a domain query. As shown in FIG. 14, webpage 1400 includes search query entry box 904, search button 906, and a search results region 1402. Similarly to FIG. 13, in FIG. 14, a user is enabled to enter a search query into search query entry box 904, such as “flickr.com” shown in FIG. 14. According to the embodiment of FIG. 14, the query “flickr.com” is processed by domain query processing module 402 to generate the query feature of “flickr”. As such, search results are enabled to be generated in response to the query. Search results for the submitted query are generated and returned by the search engine, and displayed in search results region 1402. As shown in FIG. 14, search results region 1402 includes a list of search results generated based on the query feature of “flickr”. However, no advertisements are selected for display in webpage 1400 based on the query feature of “flickr”.

As such, in FIG. 14, because the search query of “flickr.com” was processed according to embodiments to generate the query feature of “flickr”, relevant search results were able to be generated in response to the query. Furthermore, in FIG. 14, because the search query of “flickr.com” was processed according to embodiments to generate the query feature of “flickr”, lesser or non-relevant advertisements, such as the advertisement conventionally displayed in sponsored advertisements results region 1304 of FIG. 13, are not selected, and are not displayed.

Thus in embodiments, by recognizing and processing domain queries to generate query features, more relevant search results may be generated by a search engine using the generated query features. Furthermore, the generated query features may be used to select more relevant advertisements for display, as well as filtering out less relevant advertisements. In this manner, domain queries may be better monetized. Advertisers may be enabled to acquire additional customers, and users are provided with a more relevant advertisement experience, and a better engagement model. By building a domain module, which is independent of pricing, a scoring and ranking engine, the user experience, and monetization can be greatly improved for previously non-covered domain queries.

The following section describes examples of search systems that may incorporate domain query processing embodiments.

### V. Example System and Method Embodiments for Search Systems

In embodiments, domain query processing module 404 of FIG. 4 (e.g., domain query processing module 500 of FIG. 5) may be included in a search engine or in an advertisement selector of search system 402, or may be separate from a search engine and advertisement selector in search system 402.

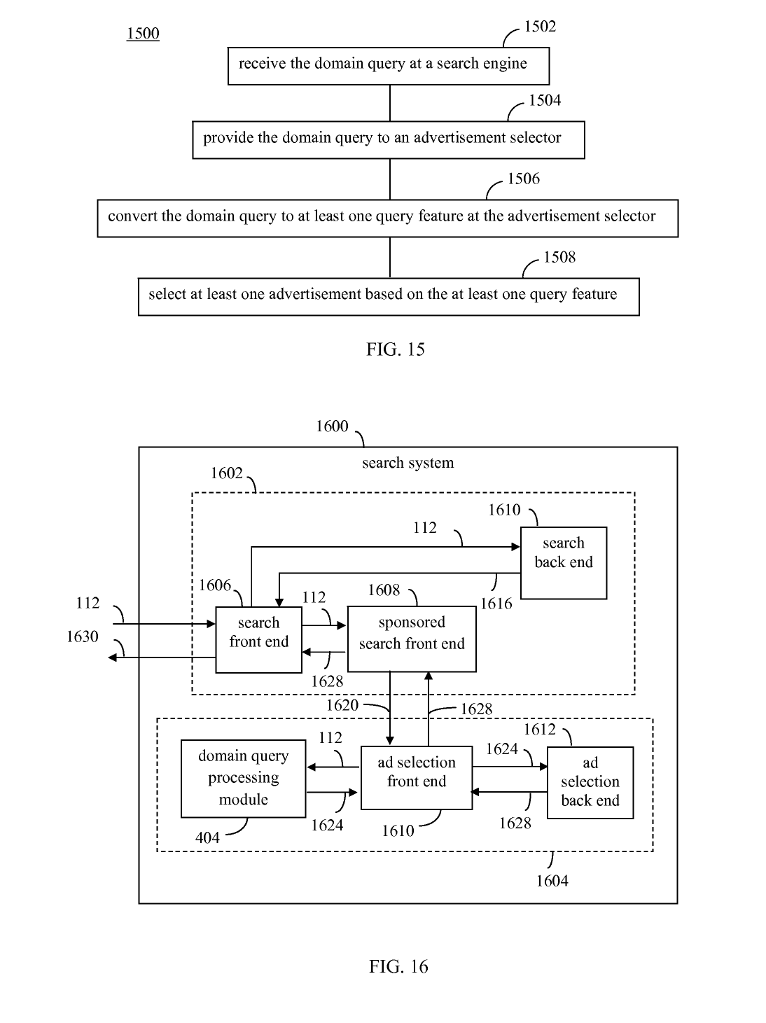

For instance, FIG. 15 shows a flowchart 1500 for processing a domain query at a search system, according to an example embodiment. In the example of flowchart 1500, the domain query is processed at an advertisement selector of a search system that includes a search engine and an advertisement selector. Flowchart 1500 begins with step 1502. In step 1502, the domain query is received at a search engine. In step 1504, the domain query is provided to an advertisement selector. In step 1506, the domain query is converted to at least one query feature at the advertisement selector. In step 1508, at least one advertisement is selected based on the at least one query feature.

Flowchart 1500 may be implemented by a variety of search systems. For instance, FIG. 16 shows a block diagram of a search system 1600, according to an example embodiment. Search system 1600 is an example of search system 402 of FIG. 4, and may operate according to flowchart 1500 of FIG. 15. As shown in FIG. 16, search system 1600 includes a search engine 1602 and an advertisement selector 1604. Search engine 1602 includes a search front end 1606, a sponsored search front end 1608, and a search back end 1610. Advertisement selector 1604 includes domain query processing module 404, an advertisement selection front end 1610, and an advertisement selection back end 1612. The elements of search system 1600 are described as follows.

As shown in FIG. 16, search front end 1606 receives query 112. Search front end 1606 is an interface for search engine 1600 for receiving queries from users. For instance, search front end 1606 may generate a search engine user interface (e.g., a web page displayable by a web browser) that provides a search engine entry box and search button that enable users to input queries.

Search back end 1610 receives query 112 from search front end 1606. Search back end 1610 is configured to generate algorithmic search results 1616 based on query 112. Search back end 1610 may be configured to generate search results based on a received query in any manner, including according to techniques known to persons skilled in the relevant art(s). For instance, search engine back end 1610 may determine a set of documents indexed by an index (e.g., index 114 of FIG. 1) that include terms of query 112 similarly to search engine 106, as described above. An indication of the set of documents may be included in search results 1616.

Sponsored search front end 1608 receives query 112 from search front end 1606, which requests sponsored advertisement listings from sponsored search front end 1608. Sponsored search front end 1608 is a communication interface for search engine 1600 with advertisement selector 1604. For instance, sponsored search front end 1608 and advertisement selector 1604 may be located in a common computer system, or may communicate over a network, including a LAN, a WAN, or a combination of networks, such as the Internet. Sponsored search front end 1608 transmits query 112 in an advertisement request 1620.

Advertisement selection front end 1610 of advertisement selector 1604 receives advertisement request 1620 from sponsored search front end 1608. Advertisement selection front end 1610 is a communication interface for advertisement selector 1604 with search engine 1602. Advertisement selection front end 1610 transmits query 112 to domain query processing module 404. As described above, domain query processing module 404 determines whether query 112 is a domain query, and if so, generates query feature(s) 1624 (e.g., query features 406 or normalized query features 704) corresponding to query 112. If domain query processing module 404 determines that query 112 is not a domain query, domain query processing module 404 may return query 112 as-is back to advertisement selection front end 1610.

If query 112 is determined to be a domain query, advertisement selection front end 1610 transmits query feature(s) 1624 to advertisement selection back end 1612. If query 112 is determined not to be a domain query, advertisement selection front end 1610 transmits query 112 to advertisement selection back end 1612.

Advertisement selection back end 1612 is configured to select one or more advertisements based on query feature(s) 1624 or query 112, and transmits an advertisement listing 1628 that indicates the selected one or more advertisements. Advertisement selection front end 1610 receives advertisement listing 1628, and transmits advertisement listing 1628 to sponsored search front end 1608. Advertisement selection back end 1612 may be configured to select advertisements based on query features in any manner, including in a manner as would be known to persons skilled in the relevant art(s). In an embodiment, advertisement selection back end 1612 may use contextual information in addition to received query features to select advertisements. Examples of such contextual information include location information associated with the user that submitted query 112 (e.g., based on an IP address of the requesting computer system), and/or any further user profile attributes associated with the user.

Search front end 1606 receives search results 1616 from search back end 1610 and receives advertisement listing 1628 from sponsored search front end 1608. Search front end 1606 transmits search results and an advertisement listing in a query response 1630. Query response 1630 is received by a computer system that transmitted query 112 (e.g., computer 104a in FIG. 1). The search results included in query response 1630 are displayed by the computer system (e.g., in a web page displayed by a web browser) to the user. Furthermore, advertisements corresponding to the advertisement listing may be requested (e.g., by the web browser) from an advertisement server. The advertisement server may transmit the advertisements to the computer system to be displayed to the user with the search results.

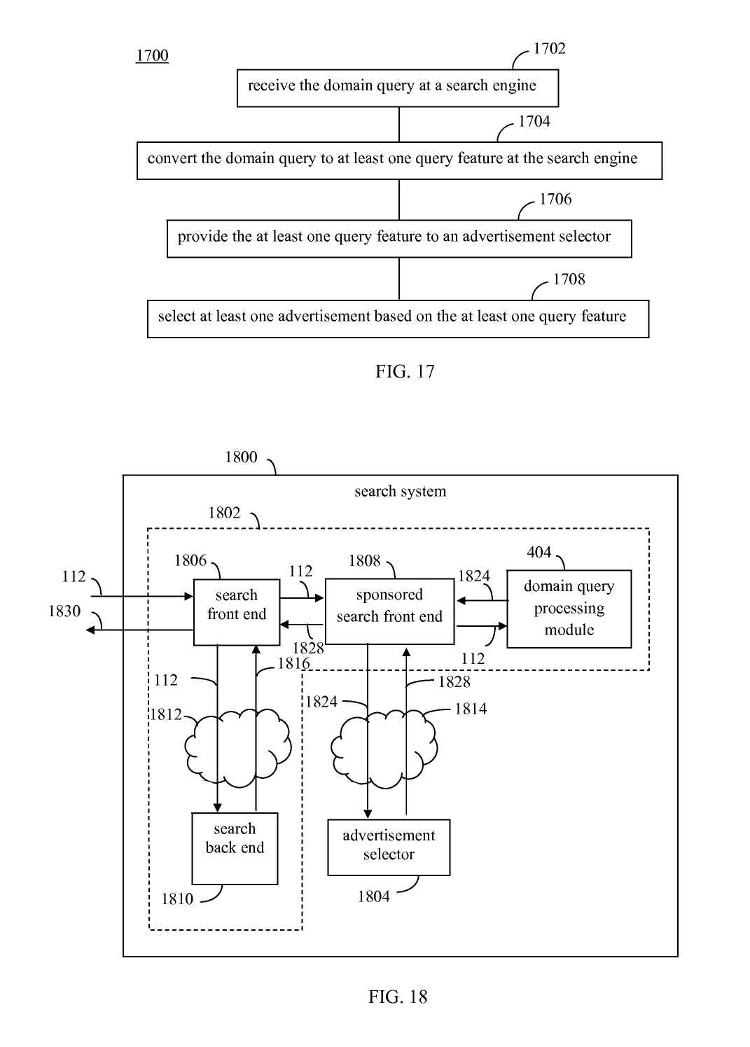

FIG. 17 shows a flowchart 1700 for processing a domain query at a search system, according to another example embodiment. In the example of flowchart 1700, the domain query is processed at a search engine of a search system. Flowchart 1700 begins with step 1702. In step 1702, the domain query is received at a search engine. In step 1704, the domain query is converted to at least one query feature at the search engine. In step 1706, the at least one query feature is provided to an advertisement selector. In step 1708, at least one advertisement is selected based on the at least one query feature.

Flowchart 1700 may be implemented by a variety of search systems. For instance, FIG. 18 shows a block diagram of a search system 1800, according to an example embodiment. Search system 1800 is an example of search system 402 of FIG. 4, and may operate according to flowchart 1700 of FIG. 17. As shown in FIG. 18, search system 1800 includes a search engine 1802 and an advertisement selector 1804. Search engine 1802 includes a search front end 1806, a sponsored search front end 1808, a search back end 1810, and domain query processing module 404. In the example of FIG. 18, search back end 1810 and search front end 1806 communicate with each other through a network 1812, and sponsored search front end 1808 and advertisement selector 1804 communicate with each other though a network 1814. Network 1812 and network 1814 may be the same network or different networks. For instance in an embodiment, search front end 1806, sponsored search front end 1808, and domain query processing module 404 may be included together in a first computer system or set of computer systems, and search back end 1810 and advertisement selector 1804 may be included together in a second computer system of set of computer systems. The elements of search system 1800 are described as follows.

As shown in FIG. 18, search front end 1806 receives query 112. Search front end 1806 is an interface for search engine 1800 for receiving queries from users. For instance, search front end 1806 may generate a search engine user interface (e.g., a web page displayable by a web browser) that provides a search engine entry box and search button that enable users to input queries.

Search back end 1810 receives query 112 from search front end 1806, which requests algorithmic search results from search back end 1810. Search back end 1810 is configured to generate search results 1816 based on the user query. Search back end 1810 may be configured to generate search results based on a received query in any manner, including according to techniques known to persons skilled in the relevant art(s). For instance, search engine back end 1810 may determine a set of documents indexed by an index (e.g., index 114 of FIG. 1) that include terms of query 112 similarly to search engine 106, as described above. An indication of the set of documents may be included in search results 1816.

Sponsored search front end 1808 receives query 112 from search front end 1806, which requests sponsored advertisement listings from sponsored search front end 1808. Sponsored search front end 1808 is a communication interface for search engine 1800 with advertisement selector 1804. For instance, sponsored search front end 1808 and advertisement selector 1804 may be located in a common computer system, or may communication over a network, including a LAN, a WAN, or a combination of networks, such as the Internet.

Sponsored search front end 1808 transmits query 112 to domain query processing module 404. As described above, domain query processing module 404 determines whether query 112 is a domain query, and if so, generates query feature(s) 1824 (e.g., query features 406 or normalized query features 704) corresponding to query 112. If domain query processing module 404 determines that query 112 is not a domain query, domain query processing module 404 may return query 112 as-is back to sponsored search front end 1808.

If query 112 is determined to be a domain query, sponsored search front end 1808 transmits query feature(s) 1824 to advertisement selector 1804. If query 112 is determined not to be a domain query, sponsored search front end 1808 transmits query 112 to advertisement selector 1804.

Advertisement selector 1804 is configured to select one or more advertisements based on query feature(s) 1824 or query 112, and transmits an advertisement listing 1828 that indicates the selected one or more advertisements. Advertisement selector 1804 may be configured to select advertisements based on query features in any manner, including in a manner as would be known to persons skilled in the relevant art(s). In an embodiment, advertisement selector 1804 may use contextual information in addition to received query features to select advertisements. Sponsored search front end 1808 receives advertisement listing 1828, and transmits advertisement listing 1828 to search front end 1806.

Search front end 1806 receives search results 1816 from search back end 1810 and receives advertisement listing 1828 from sponsored search front end 1808. Search front end 1806 transmits search results and an advertisement listing in a query response 1830. Query response 1830 is received by a computer system that transmitted query 112 (e.g., computer 104a in FIG. 1). The search results included in query response 1830 are displayed by the computer system (e.g., in a web page displayed by a web browser) to the user. Furthermore, advertisements corresponding to the advertisement listing may be requested (e.g., by the web browser) from an advertisement server. The advertisement server may transmit the advertisements to the computer system to be displayed to the user with the search results.

Note that the search system embodiments shown in FIGS. 16 and 18 are provided for purposes of illustration. Search systems embodiments may be configured in further ways, including as modified and/or combined versions of search systems 1600 and 1800, as would be known to persons skilled in the relevant art(s) from the teachings herein.

### VI. Example Computer Implementations

Search engine 106, advertisement selector 116, search system 120, search system 402, domain query processing module 404, domain query processing module 500, domain query identifier 502, domain query cleaner 504, domain query tokenizer 506, tokenized query spelling corrector 508, tokenized query normalizer 702, search system 1600, search engine 1602, advertisement selector 1604, search front end 1606, sponsored search front end 1608, search back end 1610, ad selection front end 1610, ad selection back end 1612, search engine 1802, advertisement selector 1810, search front end 1804, sponsored search front end 1806, search back end 1808, and advertisement selector 1810 may be implemented in hardware, software, firmware, or any combination thereof. For example, search engine 106, advertisement selector 116, search system 120, search system 402, domain query processing module 404, domain query processing module 500, domain query identifier 502, domain query cleaner 504, domain query tokenizer 506, tokenized query spelling corrector 508, tokenized query normalizer 702, search system 1600, search engine 1602, advertisement selector 1604, search front end 1606, sponsored search front end 1608, search back end 1610, ad selection front end 1610, ad selection back end 1612, search engine 1802, advertisement selector 1810, search front end 1804, sponsored search front end 1806, search back end 1808, and/or advertisement selector 1810 may be implemented as computer program code configured to be executed in one or more processors. Alternatively, search engine 106, advertisement selector 116, search system 120, search system 402, domain query processing module 404, domain query processing module 500, domain query identifier 502, domain query cleaner 504, domain query tokenizer 506, tokenized query spelling corrector 508, tokenized query normalizer 702, search system 1600, search engine 1602, advertisement selector 1604, search front end 1606, sponsored search front end 1608, search back end 1610, ad selection front end 1610, ad selection back end 1612, search engine 1802, advertisement selector 1810, search front end 1804, sponsored search front end 1806, search back end 1808, and/or advertisement selector 1810 may be implemented as hardware logic/electrical circuitry.

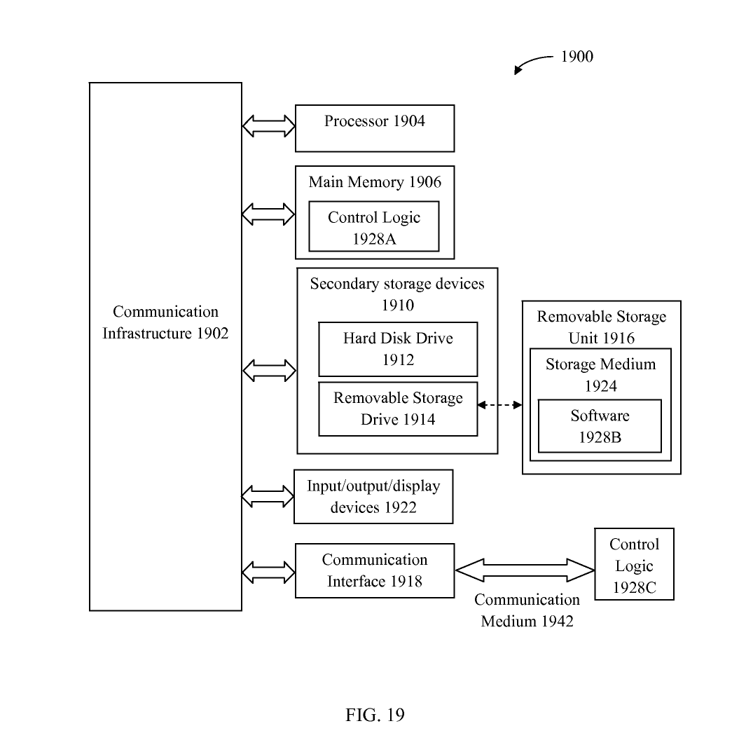

The embodiments described herein, including systems, methods/processes, and/or apparatuses, may be implemented using well known servers/computers, such as a computer 1900 shown in FIG. 19. For example, computers 104, search engine 106, advertisement selector 116, search system 120, search system 402, search engine 1602, advertisement selector 1604, search engine 1802, and/or advertisement selector 1810 can be implemented using one or more computers 1900.

Computer 1900 can be any commercially available and well known computer capable of performing the functions described herein, such as computers available from International Business Machines, Apple, Sun, HP, Dell, Cray, etc. Computer 1900 may be any type of computer, including a desktop computer, a server, etc.

Computer 1900 includes one or more processors (also called central processing units, or CPUs), such as a processor 1904. Processor 1904 is connected to a communication infrastructure 1902, such as a communication bus. In some embodiments, processor 1904 can simultaneously operate multiple computing threads.

Computer 1900 also includes a primary or main memory 1906, such as random access memory (RAM). Main memory 1906 has stored therein control logic 1928A (computer software), and data.

Computer 1900 also includes one or more secondary storage devices 1910. Secondary storage devices 1910 include, for example, a hard disk drive 1912 and/or a removable storage device or drive 1914, as well as other types of storage devices, such as memory cards and memory sticks. For instance, computer 1900 may include an industry standard interface, such a universal serial bus (USB) interface for interfacing with devices such as a memory stick. Removable storage drive 1914 represents a floppy disk drive, a magnetic tape drive, a compact disk drive, an optical storage device, tape backup, etc.

Removable storage drive 1914 interacts with a removable storage unit 1916. Removable storage unit 1916 includes a computer useable or readable storage medium 1924 having stored therein computer software 1928B (control logic) and/or data. Removable storage unit 1916 represents a floppy disk, magnetic tape, compact disk, DVD, optical storage disk, or any other computer data storage device. Removable storage drive 1914 reads from and/or writes to removable storage unit 1916 in a well known manner.

Computer 1900 also includes input/output/display devices 1922, such as monitors, keyboards, pointing devices, etc.

Computer 1900 further includes a communication or network interface 1918. Communication interface 1918 enables the computer 1900 to communicate with remote devices. For example, communication interface 1918 allows computer 1900 to communicate over communication networks or mediums 1942 (representing a form of a computer useable or readable medium), such as LANs, WANs, the Internet, etc. Network interface 1918 may interface with remote sites or networks via wired or wireless connections.

Control logic 1928C may be transmitted to and from computer 1900 via the communication medium 1942.

Any apparatus or manufacture comprising a computer useable or readable medium having control logic (software) stored therein is referred to herein as a computer program product or program storage device. This includes, but is not limited to, computer 1900, main memory 1906, secondary storage devices 1910, and removable storage unit 1916. Such computer program products, having control logic stored therein that, when executed by one or more data processing devices, cause such data processing devices to operate as described herein, represent embodiments of the invention.

Devices in which embodiments may be implemented may include storage, such as storage drives, memory devices, and further types of computer-readable media. Examples of such computer-readable storage media include a hard disk, a removable magnetic disk, a removable optical disk, flash memory cards, digital video disks, random access memories (RAMs), read only memories (ROM), and the like. As used herein, the terms “computer program medium” and “computer-readable medium” are used to generally refer to the hard disk associated with a hard disk drive, a removable magnetic disk, a removable optical disk (e.g., CDROMs, DVDs, etc.), zip disks, tapes, magnetic storage devices, MEMS (micro-electromechanical systems) storage, nanotechnology-based storage devices, as well as other media such as flash memory cards, digital video discs, RAM devices, ROM devices, and the like. Such computer-readable storage media may store program modules that include computer program logic for search engine 106, advertisement selector 116, search system 120, search system 402, domain query processing module 404, domain query processing module 500, domain query identifier 502, domain query cleaner 504, domain query tokenizer 506, tokenized query spelling corrector 508, tokenized query normalizer 702, search system 1600, search engine 1602, advertisement selector 1604, search front end 1606, sponsored search front end 1608, search back end 1610, ad selection front end 1610, ad selection back end 1612, search engine 1802, advertisement selector 1810, search front end 1804, sponsored search front end 1806, search back end 1808, advertisement selector 1810, flowchart 600, step 802, flowchart 1500, and/or flowchart 1700 (including any one or more steps of flowcharts 600, 1500, and 1700), and/or further embodiments of the present invention described herein. Embodiments of the invention are directed to computer program products comprising such logic (e.g., in the form of program code or software) stored on any computer useable medium. Such program code, when executed in one or more processors, causes a device to operate as described herein.

The invention can work with software, hardware, and/or operating system implementations other than those described herein. Any software, hardware, and operating system implementations suitable for performing the functions described herein can be used.

### IV. Conclusion

While various embodiments have been described above, it should be understood that they have been presented by way of example only, and not limitation. It will be apparent to persons skilled in the relevant art(s) that various changes in form and details can be made therein without departing from the spirit and scope of the invention. Thus, the breadth and scope of the present invention should not be limited by any of the above-described exemplary embodiments, but should be defined only in accordance with the following claims and their equivalents.

What is claimed is:

1. A method, comprising:
receiving a user query input to a search engine;
determining that the user query is a domain query;
stripping at least one domain related segment from the domain query to generate a condensed query;
tokenizing the condensed query into at least one token; and
spell correcting the at least one token to generate at least one query feature.

2. The method of claim 1, further comprising:
providing the at least one query feature to an advertisement selector to be used to select at least one advertisement.

3. The method of claim 2, further comprising:
normalizing the at least one query feature prior to said providing the at least one query feature to the advertisement selector.

4. The method of claim 1, further comprising:
selecting at least one advertisement based at least on the at least one query feature.

5. The method of claim 4, wherein said selecting comprises:
selecting the at least one advertisement based on the at least one query feature and contextual information.

6. The method of claim 4, further comprising:
transmitting the selected at least one advertisement in response to the user query.

7. The method of claim 1, wherein said stripping comprises:
removing at least one of a domain-related extension or a domain-related prefix from the domain query.

8. A search serving system, comprising:
a search front end configured to receive a user query input to a search engine; and
a domain query processing module that includes a domain query identifier, a domain query cleaner, a domain query tokenizer, and a tokenized query spelling corrector;
the domain query identifier being configured to determine whether the user query is a domain query, and if the user query is determined to be a domain query, the domain query cleaner stripping at least one domain related segment from the domain query to generate a condensed query, the domain query tokenizer tokenizing the condensed query into at least one token, and the tokenized query spelling corrector spell correcting the at least one token to generate at least one query feature.

9. The search serving system of claim 8, wherein the domain query processing module further comprises a tokenized query normalizer, and if the user query is determined to be a domain query, the tokenized query normalizer being configured to normalize the at least one query feature.

10. The search serving system of claim 8, further comprising:
a search back end configured to generate search results based on the user query.

11. The search serving system of claim 8, further comprising:
a sponsored search front end configured to provide the at least one query feature to an advertisement selector to be used to select at least one advertisement.

12. The search serving system of claim 8, further comprising:
a sponsored search front end that receives the user query from the search front end; and
an advertisement selector that includes an advertisement selection front end, an advertisement selection back end, and the domain query processing module, the advertisement selection front end receiving the user query from the sponsored search front end, the domain query processing module receiving the user query from the advertisement selection front end, and the advertisement selection back end receiving the at least one query feature from the domain query processing module and being configured to select at least one advertisement based on the at least one query feature.

13. The search serving system of claim 12, wherein the advertisement selection front end receives an indication of the selected at least one advertisement from the advertisement selection back end, and the sponsored search front end receives the indication of the selected at least one advertisement from the advertisement selection front end.

14. The search serving system of claim 13, wherein the indication of the selected at least one advertisement is transmitted to an advertisement server in response to the user query.

15. The search serving system of claim 12, wherein the advertisement selector is configured to select the at least one advertisement based on the at least one query feature and contextual information.

16. The search serving system of claim 8, wherein the domain query cleaner is configured to remove at least one of a domain-related extension or a domain-related prefix from the domain query.

17. A domain query processing module, comprising:
a domain query identifier that receives a user query input to a search engine and determines that the user query is a domain query;
a domain query cleaner that strips at least one domain related segment from the domain query to generate a condensed query;
a domain query tokenizer that tokenizes the condensed query into at least one token; and
a tokenized query spelling corrector that spell corrects the at least one token to generate at least one query feature.

18. The domain query processing module of claim 17, further comprising:
a tokenized query normalizer that normalizes the at least one query feature.

19. The domain query processing module of claim 17, wherein the domain query cleaner is configured to remove at least one of a domain-related extension or a domain-related prefix from the domain query.

20. The domain query processing module of claim 17, wherein the at least one query feature is provided to an advertisement selector to be used to select at least one advertisement.
